(19) United States
(12) Patent Application Publication
(10) Pub. No.: US 2025/0274071 A1
(43) Pub. Date: Aug. 28, 2025

(54) VERTICAL PHOTOVOLTAIC SYSTEM AND METHOD FOR ASSEMBLING SUCH A SYSTEM

(71) Applicant: ENGIE, Courbevoie (FR)

(72) Inventor: Luc BARROVECCHIO, Courbevoie (FR)

(21) Appl. No.: 18/859,794

(22) PCT Filed: Mar. 28, 2023
(86) PCT No.: PCT/EP2023/058031

§ 371 Date: Oct. 24, 2024

(30) Foreign Application Priority Data
Apr. 25, 2022 (FR) FR2203836

(51) Int. Cl. H02S 20/10; H02S 20/30

(52) U.S. Cl. CPC H02S 20/10; H02S 20/30

(57) ABSTRACT

The invention relates to a fixed vertical photovoltaic system (100), the system comprising at least:
a structure (110);
a photovoltaic module (115) supported by the structure;
a structure base (120) configured to be rigidly attached to an installation surface (102);
a means (125) for positioning the structure on the base, the positioning means being at least free to rotate and configured to position the structure according to a variable angular position of installation; and
a means (130) for securing the angular position of the means for positioning the structure relative to the structure base.

### TECHNICAL FIELD OF THE INVENTION

The present invention relates to a vertical photovoltaic system and a method for assembling such a system. It applies, in particular, to the field of the production of energy from renewable sources.

### STATE OF THE ART

In the field of the production of energy from renewable sources, the use of photovoltaic systems is an effective solution for transforming light energy into electrical energy. However, the assembly of such systems must take certain constraints present in and dependent on the installation site into account. These constraints can be defined, in particular according to the topography of the installation site. Thus, when the site has steep and variable slopes, this represents an additional difficulty when photovoltaic systems are assembled.

The solutions of the prior art do not describe photovoltaic systems suitable for intense spatial constraints inherent in the installation site.

### DESCRIPTION OF THE INVENTION

The present invention aims to remedy all or part of these drawbacks. To this end, according to a first aspect, the present invention envisages a fixed vertical photovoltaic system, which comprises at least:
a structure;
a photovoltaic module supported by the structure;
a structure base configured to be rigidly attached to an installation surface;
a means for positioning the structure on the base, the positioning means being at least free to rotate and configured to position the structure according to a variable angular position of installation; and
a means for securing the angular position of the means for positioning the structure relative to the structure base.

Thanks to these provisions, the system makes it possible to utilise a plurality of angular positions of the structure relative to the installation surface. In this way, the system can be adapted to different types of uneven terrain and can be qualified as “all-terrain”. As can be understood, the fixed vertical photovoltaic system can therefore be adapted, for example, to constraints inherent in the installation surface. In particular, the adaptability of such a photovoltaic system means a plurality of installation surfaces are available. For example, these installation surfaces are sites with variable slopes. In this way, the photovoltaic system has maximum flexibility.

In addition, when the photovoltaic system is assembled on a site whose slopes are steep and variable the use of such a system eliminates, for example, the needs to:
level the site;
perform complex positioning calculations and measurements; and/or
use complex electronic positioning systems, such as satellites.

In this way, assembling the vertical system on an installation surface is easily performed.

In some optional embodiments, the structure comprises at least one bar configured to be rigidly attached to at least one module, and the structure base comprises the means for positioning the structure.

Thanks to these provisions, the positioning means is incorporated into the structure base. Transmission of the mechanical stresses, exerted on a structure and modules towards a structure base, is therefore strengthened. For example, such stresses are static or dynamic mechanical stresses found when the photovoltaic system is assembled on a site exposed to persistent or variable strong winds. Therefore, the mechanical stresses responsible for the premature deterioration of the structure and modules are limited.

In some optional embodiments, the positioning means comprises a housing forming a shoulder, the bar comprising a shape complementary with the housing.

Thanks to these provisions, the bar is held in the housing comprised in the positioning means while retaining rotational freedom.

In some optional embodiments, the positioning means also comprises at least one slot configured to allow the positioning of the bar according to a plurality of angular positions. Thanks to these provisions, the positioning means makes it possible to increase the number of angular positions available when the photovoltaic system is assembled. In particular, when an installation site has slopes delimiting concave or convex areas, the system gives flexibility and increased adaptability.

In some optional embodiments, the structure comprises at least one bar configured to be rigidly attached to at least one module and the positioning means is arranged between the structure base and the structure.

Thanks to these provisions, the positioning means is separate from the structure base and the structure.

Therefore, replacing such a positioning means is made easier, for example when it has suffered damage or has an anomaly, without needing to replace the entire structure base or structure.

In some optional embodiments, one of the elements from amongst the positioning means and the bar comprises a hole, the other element comprising a shaft, the hole and the shaft forming a pivot link with axis of rotation perpendicular to an axis of the bar.

Thanks to these provisions, the angular position of the structure is achieved by a pivot link. Therefore, a plurality of angular positions, with one or two degrees of freedom, of the bar supporting the module is available.

In some optional embodiments, the system also comprises an additional means for positioning the structure on the base, the additional positioning means being free to rotate and comprising two elements, each element delimiting a different surface, the surfaces parallel and in contact being configured to form a pivot link with axis of rotation intersecting the installation surface.

Thanks to these provisions, the additional positioning means makes it possible to carry out an additional rotation according, for example, to constraints inherent in the installation site or the presence of an obstacle on the installation site. The photovoltaic system has an additional degree of rotational freedom. In this way, the flexibility of the photovoltaic system is improved.

In some optional embodiments, the structure comprises at least one cross-member and the structure base comprises the means for positioning this cross-member. Thanks to these provisions, the system makes it possible to utilise a cross-member that can be arranged, for example, on a plurality of positions at the location of the structure. In addition, the orientation of the cross-member can be modified by the positioning means of the structure base. A plurality of structures and an angular position variability are therefore available. In this way, the system has considerable flexibility.

In some optional embodiments, one of the elements from amongst the positioning means and the cross-member comprises a hole, the other element comprising a shaft, the hole and the shaft forming a pivot link with axis of rotation perpendicular to an axis of the structure base.

Thanks to these provisions, a plurality of angular positions, with one or two degrees of freedom, of a structure supporting a module is available.

In some optional embodiments, the photovoltaic module is rectangular, the module being secured to the structure and oriented so that a short side of the module is arranged facing the installation surface.

Thanks to these provisions, the photovoltaic module present in the photovoltaic system is secured by at least one of its long sides. In this way resistance to mechanical stresses is improved compared to a system in which a module is secured by one of its short sides. In particular, additional support is provided to the module by securing a long side of the module, enabling its layout in a configuration referred to as “portrait”. A fixed photovoltaic system that is more stable and vertical is therefore assembled on the installation surface. The system also makes it possible to reduce the footprint, and in particular to increase compatibility with agricultural activity on the installation land. In addition, such a system is therefore compatible with, for example, agrivoltaism. In particular, the system also has a low hydrological impact on the plants when it is installed on agricultural land. Therefore, coactivity is established, corresponding to the coexistence between a major agricultural activity and an efficient production of energy by one or more photovoltaic systems. This coactivity is referred to as “agrivoltaism”, also known as “Agri-PV” or “APV”.

According to a second aspect, the invention envisages a method for assembling a fixed vertical photovoltaic system, which comprises at least:
a step of rigidly attaching a structure base to an installation surface;
a step of supporting at least one photovoltaic module on a structure;
a step of positioning the structure on the structure base according to at least one variable angular position; and
a step of securing the angular position of said structure on the structure base.

As the particular aims, advantages and features of the assembly method that is the subject of the present invention are similar to those of the system that is the subject of the present invention, they are not repeated here.

### BRIEF DESCRIPTION OF THE FIGURES

Other advantages, aims and particular features of the invention will become apparent from the non-limiting description that follows of at least one particular embodiment of the system and method that are the subjects of the present invention, with reference to drawings included in an appendix, wherein:

FIG. 1 represents, schematically and in a front view, a first particular embodiment of a system that is the subject of the present invention;

FIG. 2 represents, schematically, a first particular embodiment of a positioning means according to three views: a front view on the left, a side view in the centre, and a top view on the right;

FIG. 3 represents, schematically, a second particular embodiment of a positioning means according to two views: a front view on the left, and a top view on the right;

FIG. 4 represents, schematically, a third particular embodiment of a positioning means according to two views: a front view on the left, and a top view on the right;

FIG. 5 represents, schematically and in a front view, a fourth particular embodiment of a positioning means;

FIG. 6 represents, schematically, a fifth particular embodiment of a positioning means according to two views: a front view on the left, and a top view on the right;

FIG. 7 represents, schematically, a sixth particular embodiment of a positioning means according to two views: a front view on the left, and a top view on the right;

FIG. 8 represents, schematically, a seventh particular embodiment of a positioning means according to two views: a front view on the left, and a top view on the right;

FIG. 9 represents, schematically and in a top view, an eighth particular embodiment of a positioning means;

FIG. 10 represents, schematically and in a top view, elements of the eighth particular embodiment of a positioning means represented in FIG. 9;

FIG. 11 represents, schematically and in a front view, a particular embodiment of a structure of a system;

FIG. 12 represents, schematically and in a front view, several particular embodiments of a structure of a system;

FIG. 13 represents, schematically and in a front view, a second particular embodiment of a system that is the subject of the present invention;

FIG. 14 represents, schematically and in a front view, a variant of the second embodiment represented in FIG. 13;

FIG. 15 represents, schematically and in a front view, a variant of the second embodiment represented in FIG. 13;

FIG. 16 represents, schematically and in a front view, a particular embodiment of a structure of a system;

FIG. 17 represents, schematically and in a front view, a particular embodiment of a structure represented in FIG. 16 supporting photovoltaic modules;

FIG. 18 represents, schematically and in a side view, two particular embodiments of a cross-member;

FIG. 19 represents, schematically, in a top view and in cross-section, a first particular embodiment of a bar;

FIG. 20 represents, schematically, in a top view and in cross-section, a particular bar, module and securing means assembly;

FIG. 21 represents, schematically, in a side view and in cross-section, five particular embodiments of a secondary cross-member;

FIG. 22 represents, schematically, in a side view and in cross-section, three particular embodiments of a secondary cross-member;

FIG. 23 represents, schematically, in a side view and in cross-section, three particular embodiments of a secondary cross-member; and

FIG. 24 represents, schematically and in the form of a logic diagram, a particular series of steps of a method that is the subject of the present invention.

### DESCRIPTION OF THE EMBODIMENTS

The present description is given in a non-limiting way, in which each characteristic of an embodiment can be combined with any other characteristic of any other embodiment in an advantageous way.

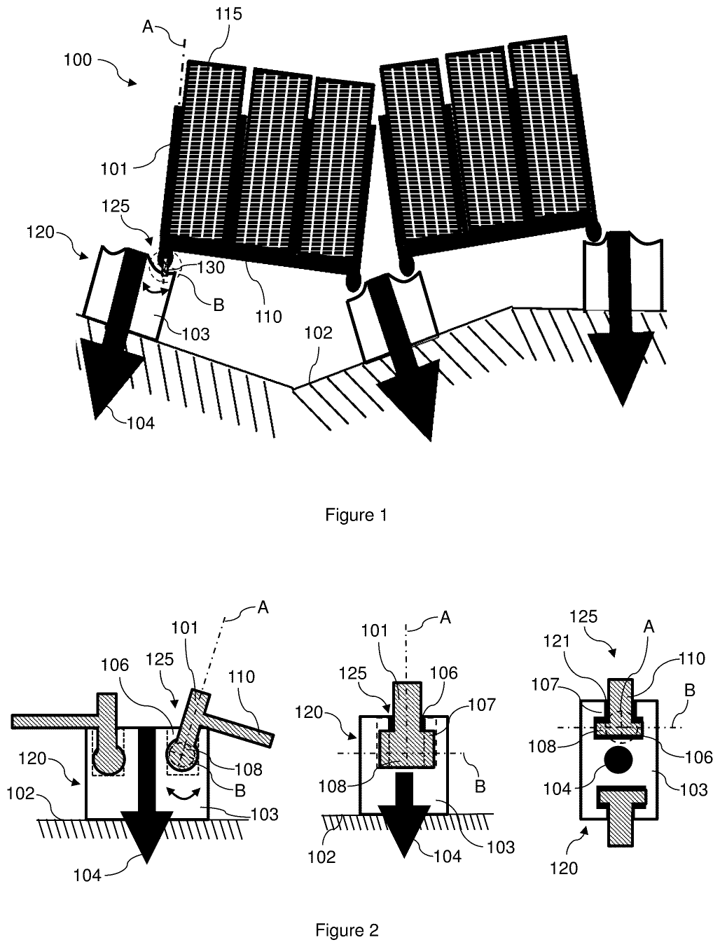

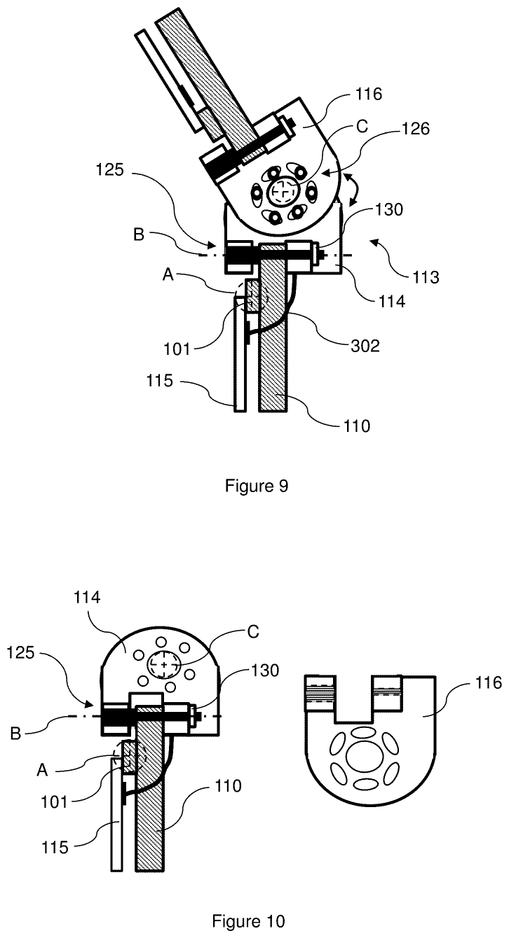

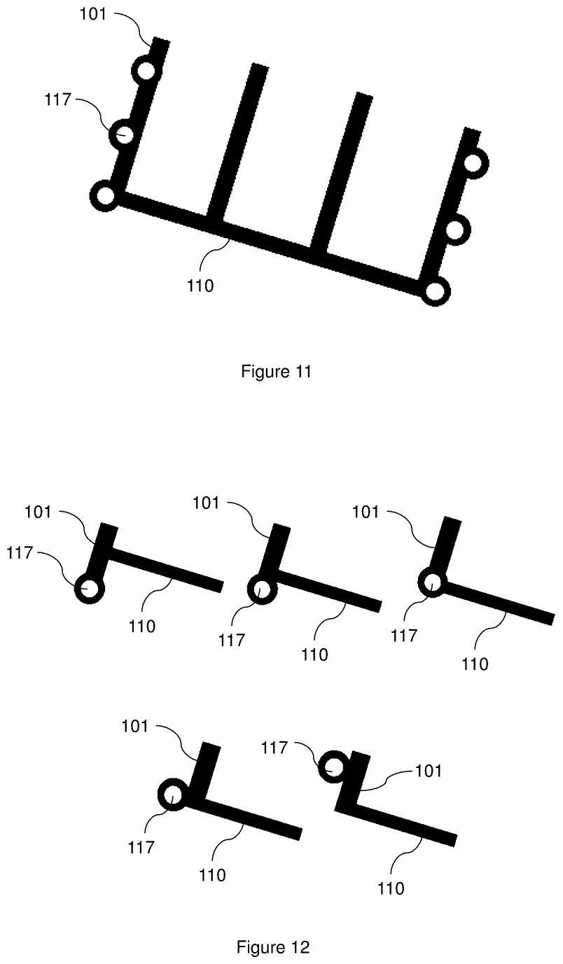

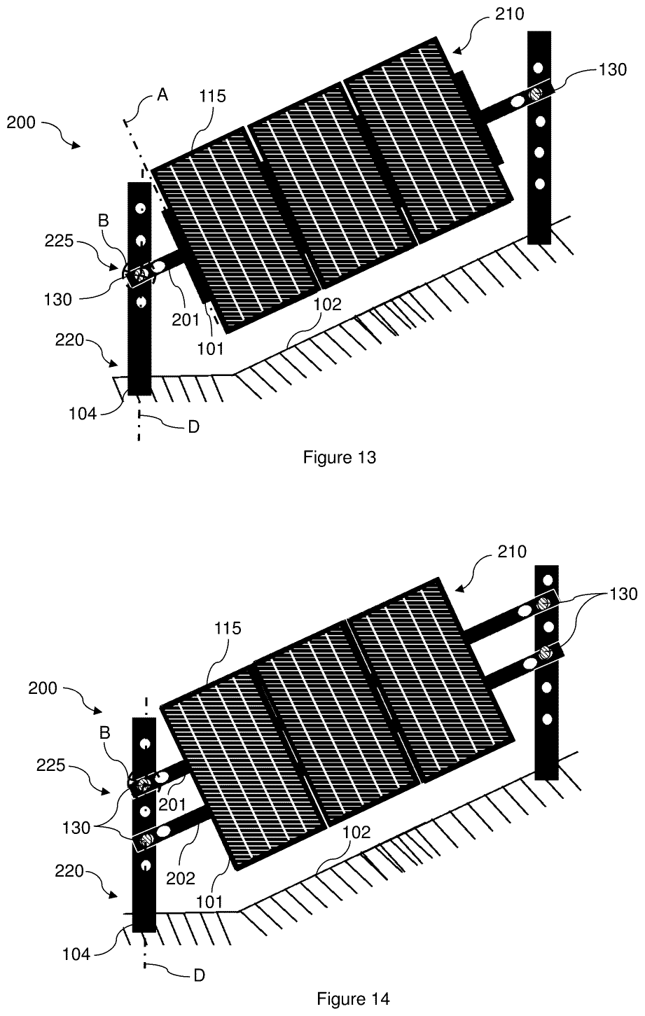

Throughout the description, the term “upper” refers to being located at the top in FIGS. 1, 2 on the left and in the centre, 3 on the left, 4 on the left, 5, 6 on the left, 7 on the left, 8 on the left, 13 to 15 and 17, 18, 21 to 23, which corresponds to the normal use configuration of the system, and “lower” to being located at the bottom in these FIGS. 1, 2 on the left and in the centre, 3 on the left, 4 on the left, 5, 6 on the left, 7 on the left, 8 on the left, 13 to 18, 21 to 23. The term “back” refers to being located to the rear of the plane of the FIGS. 1, 13 to 15 and 17, and “front” to being located at the front of the plane of the FIGS. 1 and 13 to 15. The terms “vertical” and “horizontal” flow from these definitions. The term “top” refers to being located at, or oriented towards, the top, in FIGS. 12, 19 and 21, and “bottom” to being located at the bottom in FIGS. 12, 19 and 21. The term “left” refers to being located on the left in FIGS. 2 to 4, 6 to 8, 10, 18, 21, 22 and 23. The term “right” refers to being located on the right in FIGS. 2 to 4, 6 to 8, 10, 18, 22 and 23. The term “centre” refers to being located in the centre in FIGS. 2, 19, 22 and 23. The systems shown in FIGS. 1 to 10 and 13 to 15 each have an axis A corresponding to an axis of a bar, and an axis B corresponding to an axis of rotation of a positioning means when the systems are not fixed, the axis B being perpendicular to axis A of the bar and preferably to the plane formed by the module. The systems shown in FIGS. 13 to 15 each have an axis D corresponding to an axis of a structure base and an axis B corresponding to an axis of rotation of a positioning means when the systems are not fixed, the axis B being perpendicular to the axis D. The system shown in FIG. 9 has an axis C of a second positioning means intersecting the installation surface and perpendicular to the axis B.

The following definitions are noted here:

The term “bifacial module” refers to a module producing electricity using both of its faces. The faces of a module are the two surfaces having the largest dimensions. A bifacial module allows the light to be transmitted to the front face and back face of its photovoltaic cells, themselves bifacial.

The bifacial photovoltaic cells can produce electricity using both of their faces. In general, there is a junction box on the back face of the module, and the power generated by the back face is usually less than the power generated by the front face. The term “double-glass module” refers to a module having a front face made of glass and a back face made of glass.

The term “increased electricity production” refers to an increase in the production of electricity, for example due to a larger amount of solar energy reaching the photovoltaic cells of the module.

The term “facing the ground” refers to an installation configuration in which one short side of the photovoltaic module is closer to the ground than the other short side of the photovoltaic module when the photovoltaic module is rectangular.

The term “C-shaped”, used to define the shape of a cross-member, refers to a general shape having:
a support side, which supports an element and is substantially horizontal;
a side opposite the support side, which does not support an element and is substantially horizontal;
   the support side and the opposite side being connected by two sides, these two sides corresponding to a front side and a back side, the front side or the back side being at least partially free of material.

The term “U-shaped”, used to define the shape of a cross-member, refers to a general shape having:
a support side, which supports an element and is substantially horizontal;
a side opposite the support side, which does not support an element and is substantially horizontal and partially free of material;
   the support side and the opposite side being connected by two sides, these two sides corresponding to a front side and a back side.

The term “installation surface” refers to a surface on which a photovoltaic system is assembled or arranged. For example, such a surface refers to an installation ground. For example, such an installation ground is agricultural land.

The term “static or dynamic mechanical stresses” refers to stresses exerted on a photovoltaic system. In particular, these stresses are dependent on the characteristics of the installation site. For example, such stresses are exerted by the wind applied on the surface of a photovoltaic module.

The term “vertical photovoltaic system” refers to a system or a part of a system delimiting at least one plane substantially vertical to an installation surface. For example, the installation surface forms a horizontal plane.

The term “fixed photovoltaic system” refers to a system having a fixed spatial position, in particular angular and linear. In other words, a fixed photovoltaic system does not correspond to a mobile photovoltaic system. Such a mobile photovoltaic system is, for example, a system whose modules will be actuated according to the path of the sun. It is now noted that the figures are not to scale.

FIG. 1, which is not to scale, shows a schematic view of an embodiment of a system 100 that is the subject of the present invention. It can be seen that the fixed vertical system 100 comprises at least one structure 110 and at least one photovoltaic module 115 supported by the structure 110.

It can be seen that the system 100 also comprises:
a structure base 120;
a means 125 for positioning the structure 110 on the structure base 120; and
a means 130 for rigidly attaching the positioning means 125.

Note that:
the structure base 120 is configured to be rigidly attached to an installation surface 102;
the positioning means 125 is at least free to rotate and configured to position the structure 110 according to a variable angular position of installation; and
the attachment means 130 is configured to secure the angular position of the structure 110 relative to the structure base 120.

In some embodiments, such as the one shown in FIG. 1, the surface delimited by the photovoltaic cells of a photovoltaic module 115 forms a parallelepiped.

In some embodiments (not shown), at least two photovoltaic modules 115 are arranged vertically, one photovoltaic module 115 being arranged above the other photovoltaic module 115 in a system 100.

In some embodiments, the photovoltaic module 115 is framed. In some variants, the photovoltaic module 115 is frameless. In other words, the securing edge of the module 115 has no securing frame. For example, the photovoltaic module 115 is a double-glass module with no frame.

In some embodiments, such as the one shown in FIG. 1, the photovoltaic module 115 is rectangular. It can be seen that the module 115 is secured to the structure 110 and oriented so that a short side of the module 115 is arranged facing the installation surface 102.

In some embodiments, such as the one shown in FIG. 1, the structure 110 supporting at least one photovoltaic module 115 is a cradle. FIG. 1 shows three photovoltaic modules 115 supported by a cradle 110. In particular, the cradle 110 comprises a lower horizontal element supporting a short side of the rectangular photovoltaic modules 115. For example, such a horizontal element is a cross-member. Note that the cradle 110 also comprises vertical elements rigidly attaching the long sides of the photovoltaic modules 115. For example, such vertical elements correspond to bars or posts.

In some embodiments, such as the one shown in FIG. 1, the structure base 120 is configured to be rigidly attached to an installation surface 102. Note that the structure 120 can comprise several assemblable parts. FIG. 1 shows the structure base 120 comprising a stud 103. The stud 103 is, for example, made of concrete or metal. For example, the stud 103 is passed through by an element 104 anchored in an installation ground 102, such an element being configured to securely attach the structure base 102. The element 104 is, for example, a post anchored in the ground or a set of screws.

Note that the cradles 110, shown in FIG. 1, are, for example, assembled in the factory and then brought to the installation site 102, assembled in a specific assembly area, or assembled on the installation site 102.

FIG. 1 shows a single structure base 120 supporting two cradles 110. In some variants, the two cradles 110 are supported by two different structure bases 120. In some embodiments, such as those shown in FIG. 1, the system 100 comprises:
a structure 110 comprising at least one bar 101 having an axis A, the bar being configured to be rigidly attached to at least one module 115; and
a structure base 120 comprising the means 125 for positioning the structure.

FIG. 1 shows a bar 101 of the structure 110 having an axis A, this axis being parallel to a largest dimension of the bar 101. For example, when the bar 101 is a tapered cylinder, the axis A is parallel to a generatrix of the tapered cylinder. For example, when the bar 101 is polyhedral, the axis A is parallel to an edge having a largest dimension.

In some embodiments, such as the one shown in FIG. 2, the positioning means 125 comprises a housing 106. The housing 106 has a shape configured to surround an extremity of the bar 101. Note that the extremity of the bar 101 has a shape 108 complementary with the housing 106. The housing 106 forms a shoulder 107, as shown in the centre and on the right in FIG. 2. The shoulder 107 abuts with the shape 108 of the extremity of the bar 101 and thus keeps the shape 108 in the housing 106. In other words, the stop formed by the shoulder 107 prevents the complementary shape 108 being dislodged.

FIG. 2 shows the positioning means 125 being at least free to rotate on an axis B when the system 100 is assembled. The positioning means 125, through its rotational freedom during its assembly, is configured to position the structure 110 according to a variable angular position of installation. The rotational freedom of the positioning means 125 is indicated on the left in FIG. 2 by a curved double-headed arrow. Through such a rotational freedom, a multitude of angular positions are available to provides the system 100. Preferably, the elements of the means 125 form a pivot link. In particular, the different angles defining the angular positions associated with this pivot link are comprised in a plane generally perpendicular to the installation surface 102 or to a horizontal plane.

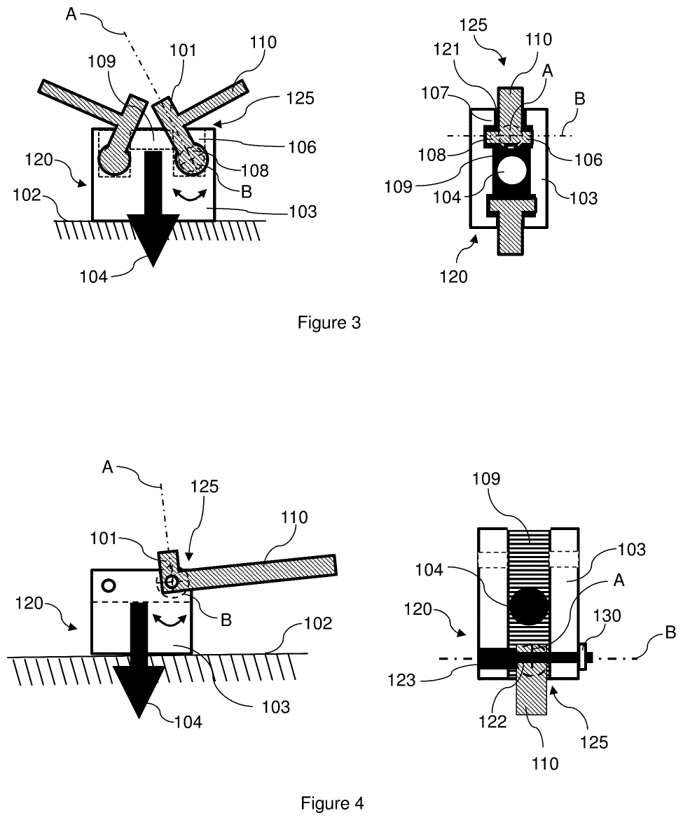

In some embodiments, such as those shown in FIGS. 2 and 3, the positioning means 125 comprises at least one slot, 109 and/or 121. The slot, 109 and/or 121, is configured to allow the positioning of the bar 101 according to a plurality of angular positions. In particular, a side slot 121, shown on the right in FIG. 2, provides an additional rotational range to the pivot link with axis of rotation B. In other words, the stud 103 comprises a side slot 121, also called side opening, so as to easily vary the inclination of the cradle 110. In some variants, such as the one shown in FIG. 3, a central slot 109, also provides an additional rotational range to the pivot link with axis of rotation B. In particular, such a central slot 109 increases the adaptability of the system 100 when the installation site 102 has, for example, a convex or concave surface.

In some embodiments (not shown), a means 130 for rigidly attaching the positioning means 125 comprises at least one bolt. For example, a stud 103 and the extremity of a bar 101 each have a hole with tapping, the holes being aligned and the tapping being adapted to the threading of the bolt. In other words, the bolt is screwed through the stud 103 and in the extremity of the bar 101. In other examples, only the stud comprises a hole with tapping and the bolt, when it is screwed, pushes the extremity of the bar 101 up to a stop. In other embodiments (not shown), the attachment 130 of the positioning means 125 comprises at least two bolts. These bolts are screwable according to the same structural characteristics defined above.

In some embodiments (not shown), a stud 103 has a through-opening, and an attachment means 130 comprises an assembly formed of a cross bar and a bolt. Such a cross bar has at least one dimension larger than the opening of the stud 103. For example, the cross bar and the extremity of the base comprise a hole with tapping. The holes are aligned and the tapping adapted to the threading of the bolt. In particular, when the attachment means 130 secures an angular position, the bolt is screwed and rigidly attaches the cross bar and the bar 101 of the structure 110. Note than such a cross bar is in contact with the stud 103 when the bolt is screwed. In some variants, another assembly comprising a cross bar and a bolt rigidly attaches the bar 101 of the structure 110 to the stud 103 on the other side of the through-opening.

In some embodiments, such as the one shown in FIG. 4, the extremity of the bar 101 of the structure 110 comprises a hole 122 and the positioning means 125 comprises a shaft 123. Note that the hole 122 and the shaft 123 form a pivot link with axis of rotation B perpendicular to the axis A of the bar 101.

In some embodiments, such as the one shown in FIG. 4, the positioning means 125 and the attachment means 130 have elements in common, such as the shaft 123 and the hole 122. Note that the attachment means 130 also comprises a nut enabling the angular position of the pivot link to be secured. In other words, the bar 101 is immobilised in the stud 103 by the tightening of the bolt on the surface of the stud 103. FIG. 4 shows the axis 123 comprising a shoulder configured to press the structure 110 against the stud 103 when the bolt 130 is screwed.

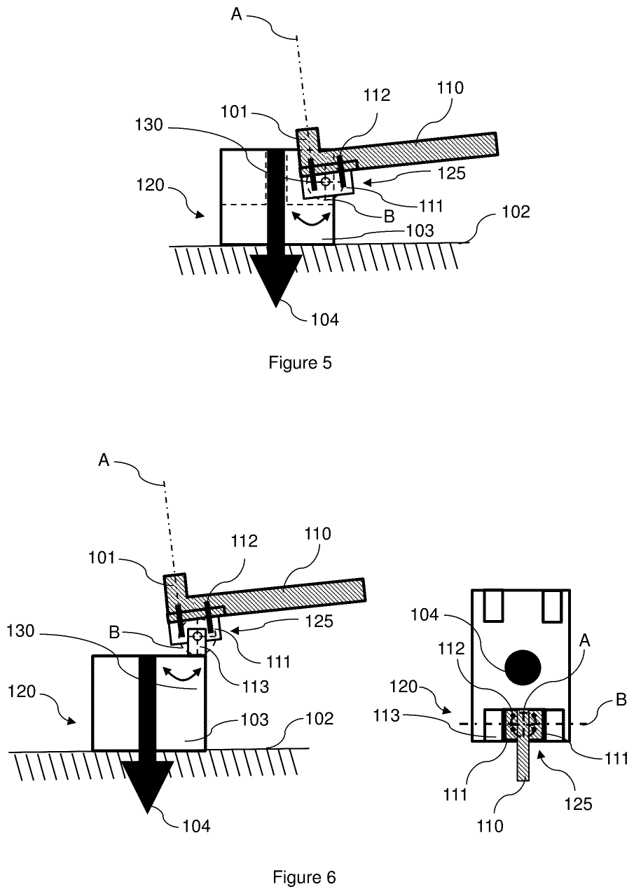

In some variants, such as the one shown in FIG. 5, the bar 101 is rigidly attached to a rotationally free intermediate element 111. Note that the intermediate element 111 is, for example:
bolted to the structure 110, and
secured to the stud 103 by an attachment means, such an attachment means having structural characteristics similar to those described above.

In some embodiments, such as those shown in FIGS. 6 to 10, the system 100 comprises:
a structure 110 comprising at least one bar 101 having an axis A, the bar 101 being configured to be rigidly attached to at least one module 115; and
a positioning means 125 arranged between the structure base 120 and the structure 110.

In some embodiments, such as the one shown in FIG. 6, the positioning means 125 comprises an intermediate part 113 and an intermediate element 111 arranged between the structure base 120 and the structure 110. In other words, the intermediate part 113 and the intermediate element 111 are rigidly attached, and are arranged above the stud 103. FIG. 6 shows the structure 110 rigidly attached to the intermediate element 111 by a screw set 112. Note that one of the elements from amongst the intermediate part 113 and the intermediate element 111 comprises a shaft, the other element comprising a hole, the shaft and the hole forming a pivot link. Such a pivot link and the attachment means 130 can be produced in a similar way to the embodiments described in FIG. 5.

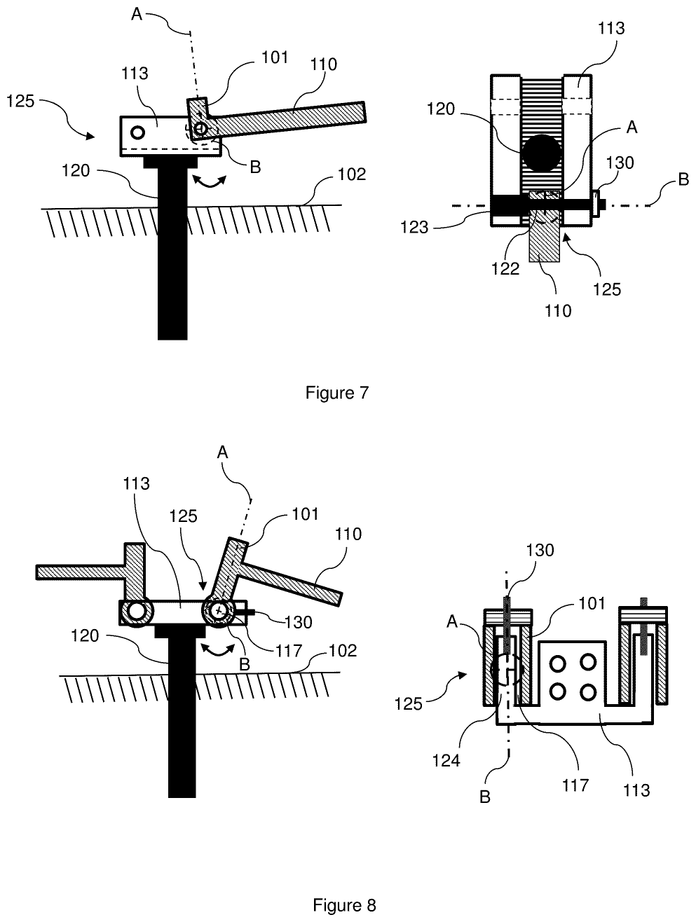

In some embodiments, such as the one shown in FIG. 7, the positioning means 125 also comprises a panel 113 arranged between the structure base 120 and the structure 110. Note that the structural characteristics mentioned previously for the positioning means 125 shows in FIGS. 4 and 5 are also valid for the positioning means 125 shown in FIG. 7.

In some embodiments, such as the one shown in FIG. 8, a panel 113 separates the base 120 and the structure 110. Note that, in these embodiments, a portion of a bar 101 of the structure 110 is slid to the location of a cylindrical bar 124 of the panel 113.

Note that the axis B is parallel to a generatrix of the cylindrical bar 124. The portion of the bar 101 of the structure 110 is immobilised in an angular position by an attachment means 130 comprising for example, a bolt and nut system.

In these embodiments, such as the one shown on the left in FIG. 8, the system 110 comprises a hole 117. This hole has a circular shape, the inside of the circle having a through recess. The hole 117 is also called “rotation point”. A cylindrical bar 124 of the panel 113 forms a shaft. Thus, the hole 117 and the cylindrical bar 124 form a pivot link having axis of rotation B. Note that the panel 113 is positioned at the location of this hole 117 and has, for example, a dimension less than or equal to the outer diameter of the circular shape. Thus, a plurality of angular positions can be realised through this arrangement. On the left in FIG. 8, the rotational freedom of the positioning means 125 is shown by a curved double-headed arrow.

In some variants, such as those shown in FIGS. 11 and 12, one or more holes 117 are arranged at different locations of the structure 110. These holes 117 are positioned on the structure 110, also called cradle 110, to improve the flexibility of installation on a site 102 with slopes. For example, the number and position of the holes 117 on the cradle 110 will be chosen according to the steepness of the slopes of the installation site 102.

In some embodiments, such as those shown in FIGS. 9 and 10, the system 100 also comprises an additional means 126 for positioning the structure 110 on the base 120. Such an additional means 126 is free to rotate. In these embodiments, the positioning means 125 and the additional positioning means 126 are on a single element 113 corresponding to a panel.

In these embodiments, the additional second positioning means 126 comprises two elements, 114 and 116. In particular, a panel 113 has two parts, 114 and 116. Note that each note, 114 and 116, delimits a different surface, the surfaces being parallel and in contact. Such surfaces are configured to form a pivot link with axis of rotation C intersecting the installation surface 102. Preferably, the axis of rotation C is perpendicular to the installation surface 102 or to the horizon. In addition, this pivot link on the axis C is perpendicular to the axis of rotation B of another pivot link. In particular, the different angles defining the angular positions associated with this pivot link are comprised in a plane generally parallel to the installation surface 102. Note that such a pivot link of the additional positioning means 126 forms a hinge.

In some embodiments (not shown), the panel 113 is offset in relation to the structure base 120 to facilitate the inclination of the cradle 110.

In some embodiments, the passage of the cables 302 of the modules 115 is carried out above or below the panel 113. In some variants, a protection raceway for cables 302 is incorporated into the panel 113.

FIG. 13, which is not to scale, shows a schematic view of an embodiment of a system 200 that is the subject of the present invention.

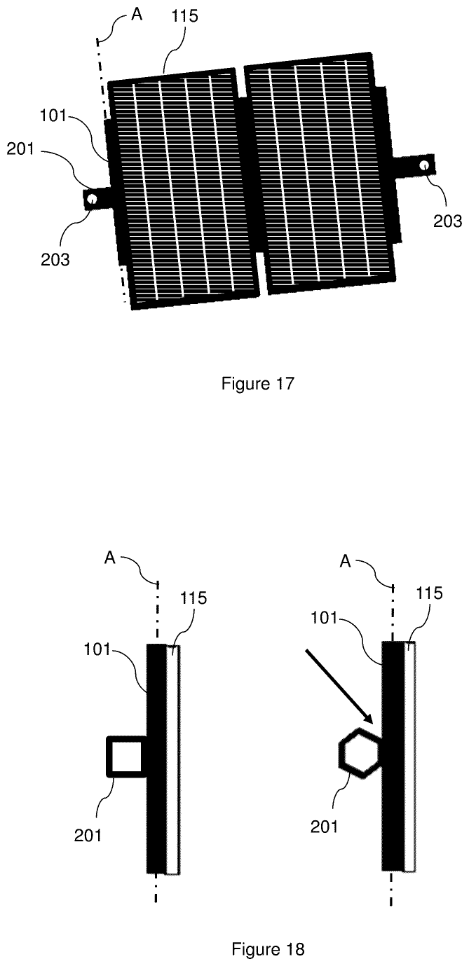

FIG. 13 shows the fixed vertical photovoltaic system 200 comprising at least one structure 210 and at least one photovoltaic module 115 supported by the structure 210. Such a structure 210 is also shown in FIGS. 16 and 17.

It can be seen that the system 200 also comprises:
a structure base 220;
a means 225 for positioning the structure 210 on the structure base 220; and
a means 130 for rigidly attaching the positioning means 225.

Note that:
the structure base 220 is configured to be rigidly attached to an installation surface 102;
the positioning means 225 is at least free to rotate and configured to position the structure 210 according to a variable angular position of installation; and
the attachment means 130 is configured to secure the angular position of the structure 210 relative to the structure base 220.

In some embodiments, such as the one shown in FIG. 13, the structure base 220 comprises a part anchored in the ground of the installation site 102. The structure base 220 comprises, in particular, a post 104 or a stake 104 rigidly attached to the installation surface 102.

In some embodiments, such as those shown in FIGS. 13 to 15, the photovoltaic system 200 comprises a structure 210 comprising at least one cross-member 201. In some embodiments, such as the one shown in FIG. 16, the cross-member 201 has different profiles. The cross-member 201 has a square profile on the left in FIG. 18 and a hexagonal profile on the right in FIG. 18. Preferably, the profile of the cross-member 201 is hexagonal. In that case, the direct and diffuse solar radiation of the photovoltaic module, represented by an arrow on the right in FIG. 18, is maximised.

In some embodiments, such as the one shown in FIG. 13, the photovoltaic system 200 also comprises a structure base 220 comprising the means 225 for positioning the cross-member 201.

FIG. 13 shows the structure 210, which comprises at least one bar 101 supporting one or two photovoltaic modules 115. Preferably, each axis A of a bar 101 is perpendicular to a longitudinal axis of the cross-member 201. Note that the bars 101 are also called “parallel bars”. The cross-member 201 is secured to the parallel bars 101 by any method known to the person skilled in the art.

In these embodiments, the cross-member 201 comprises a hole 203, shown in FIGS. 16 and 17. Note that the structure base 220 comprises, for example, a shaft (not shown). The hole 203 and the shaft form a pivot link with axis of rotation B perpendicular to an axis D of the structure base 220. In other words, the cross-member 201 is at least free to rotate on the axis B. For example, when the base 220 is a tapered cylinder, the axis D is parallel to a generatrix of the tapered cylinder. For example, when the bar 101 is polyhedral, the axis D is parallel to an edge having a largest dimension.

In some embodiments, such as the one shown in FIG. 13, the attachment means 130 comprises a bolt. In particular, the bolt of the attachment means 130 secures the cross-member 201 and the structure base 220 according to a predetermined angular position. In other words, the portion of the cross-member 201 of the structure 210 is immobilised in an angular position by an attachment means 130.

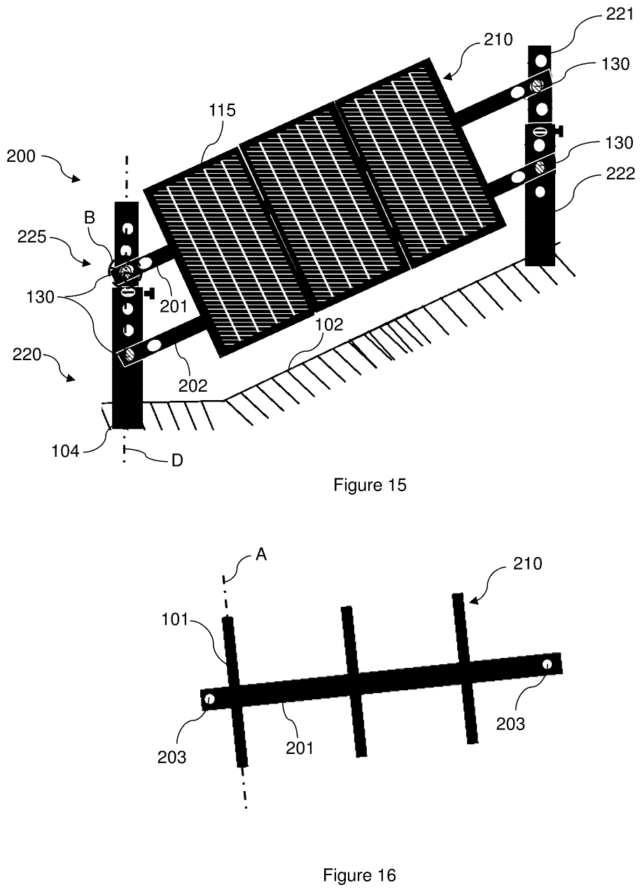

In some variants, such as those shown in FIGS. 14 and 15, the structure 210 comprises an additional cross-member 202. In other words, the structure 210 comprises a lower cross-member 202 and an upper cross-member 201. In particular, the photovoltaic modules 115 are rigidly attached to two cross-members, 201 and 202, preferably parallel to each other. Note that a structure base 220 is secured, by an attachment means 130, to an extremity of each cross-member, 201 and 202.

Preferably, the structure base 220 has a lower part 222 and an upper part 221, as shown in FIG. 15. Note that the lower part 222 forms a slide channel, and that the upper part 221 forms a slide, the slide channel and slide forming a sliding link. The sliding link is immobilised, for example, by bolts or by any method known to the person skilled in the art. In particular when the bolts are screwed, the lower part 222 exerts pressure on the upper part 221, immobilising the sliding link. Such a sliding link is configured to adjust the height of the structure base 220 according, for example, to the slope of the installation site. In addition, a constant spacing is obtained between the two cross-members, 201 and 202. Thus, the mechanical stresses applied at the location of clips arranged between cross-members, 201 and 202, and the photovoltaic modules 115 are limited.

In some embodiments, such as those shown in FIGS. 13 to 15, the photovoltaic module 115 is rectangular. It can be seen that the module 115 is secured to the structure 210 and oriented so that a short side of the module 115 is arranged facing the installation surface 102.

The following embodiments and variants are valid for the systems 100 and 200, unless otherwise indicated.

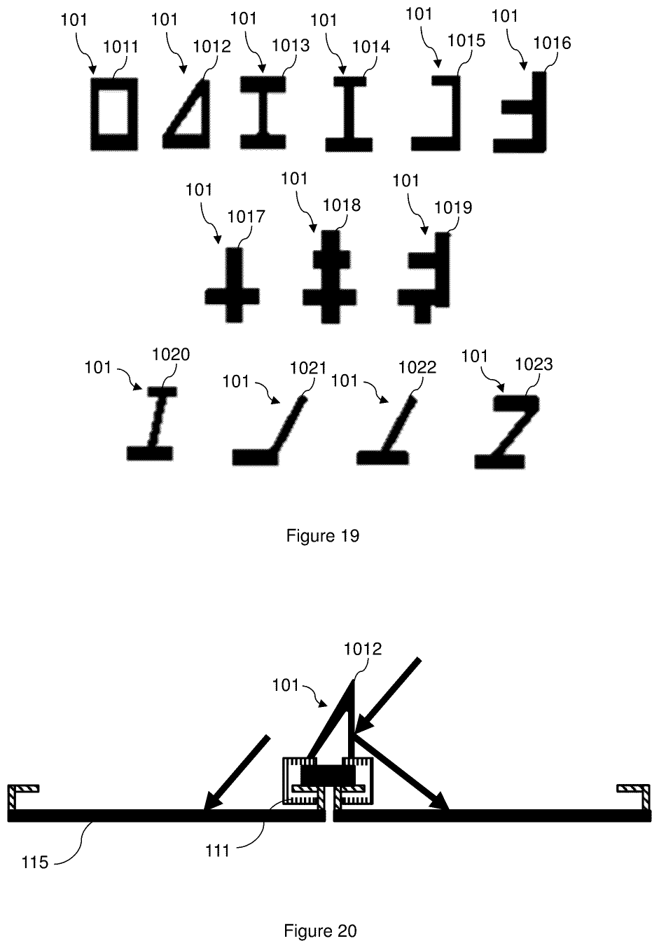

In some embodiments, such as those shown in FIG. 19, at least one bar 101 has a cross-sectional profile, 1011, 1012, 1013, 1014, 1015, 1016, 1017, 1018, 1019, 1020, 1021, 1022 or 1023, with the following shape:
triangle 1012, also shown in FIG. 20;
rectangle 1011;
symmetrical H 1013;
asymmetrical H 1014;
inclined H 1020;
cross, 1017, 1018 and 1019;
C 1015;
F 1016;
T not shown);
inclined T 1022;
offset inclined T 1021; or
inclined Z 1023.

FIG. 20 shows the path of the solar radiation, represented by arrows. Notably, when the bar 101 is made of a material at least partially reflective, a portion of the light rays reaching the bar 101 is reflected towards the module 115. Electricity production is thus increased when the module 115 is bifacial.

Note that the choice of the cross-sectional profile of the bar 101, from amongst the cross-sectional profiles mentioned above, is made based, for example, on:
the mechanical resistance desired;
the installation constraints;
minimising production and installation costs; and/or
a reduced vertical shadow behind the module 115 when the module 115 is bifacial.

Thus, the ease of installation and mechanical resistance of the photovoltaic system, 100 or 200, are improved. In addition, the system, 100 or 200, has a reduced vertical shadow on the back face of the module 115. When the module 115 is bifacial, the electricity production is therefore increased. In addition, when the bar 101 has one of the various cross-sectional profiles mentioned above and is at least partially made of a reflective material, an optimum reflection of the sunlight on the photovoltaic module 115 is achieved. This boosts the increased electricity production.

In some embodiments, the photovoltaic module 115 of a system, 100 or 200, is secured to a bar 101 by:
at least one bolt and nut assembly (not shown), making it possible, in particular, to prevent the photovoltaic module 115 from detaching and slipping;
at least one clip system, as shown in FIG. 20, making it possible, in particular, to prevent the photovoltaic module 115 from detaching;
at least one spring (not shown); and/or
at least one gripper, for example a clamp (not shown).

In some embodiments, the front surface of the photovoltaic module 115 is aligned to the front surface delimited by a bar 101 of a system, 100 or 200. In other words, the front surface of the photovoltaic module 115 is not set back with respect to the front surface delimited by a bar 101.

In these embodiments, the exposure of the front face of the photovoltaic module 115 to the light rays is increased since the shadows are reduced. Note that, when the photovoltaic module 115 is bifacial, this preferred exposure of the front face results in larger shadows cast on the back face. However, the efficiency of the conversion of solar energy into electrical energy is higher for the front face of the module 115 compared to the back face of the module 115. Therefore, despite the presence of shadows on the back face of the module 115, the increased electricity production is boosted by this preferred exposure to light rays of the front face of the module 115. Note that, when the front face of the module 115 is preferably exposed to the light rays, such a solution is less demanding with respect to bifaciality. In other words, the positioning of the photovoltaic module 115 is not dependent on the bifaciality. Therefore, a wider choice of photovoltaic modules 115 is available for a system, 100 or 200, including in particular photovoltaic modules 115 with a smaller economic cost.

When a photovoltaic system, 100 and 200, with at least one row of modules 115 is installed, the front faces of the modules 115 can be oriented according to a performance choice for the system, 100 and 200. For example, the front faces of the modules 115 are oriented due East through to an orientation due West. Therefore there is a significant degree of freedom in the orientation of a row of modules 115. Thus a range of electrical profiles is available according to the orientation of a row of a photovoltaic system, 100 or 200, and according to the choice of the surface of the bars 101 to be aligned to the front face of the module 115. In particular, such a flexibility of orientation is utilised, for example, to:
adjust the system, 100 and 200, to the spatial constraints inherent in the installation site; and/or
position the system, 100 and 200, so as to reduce exposure to strong prevailing winds.

In some variants, when the installation site 102 is agricultural land, the flexibility of orientation is utilised for installing, for example, rows in a straight line from South to North. Such a photovoltaic system, 100 and 200, is preferably installed so that the agricultural land receives a uniform amount of light.

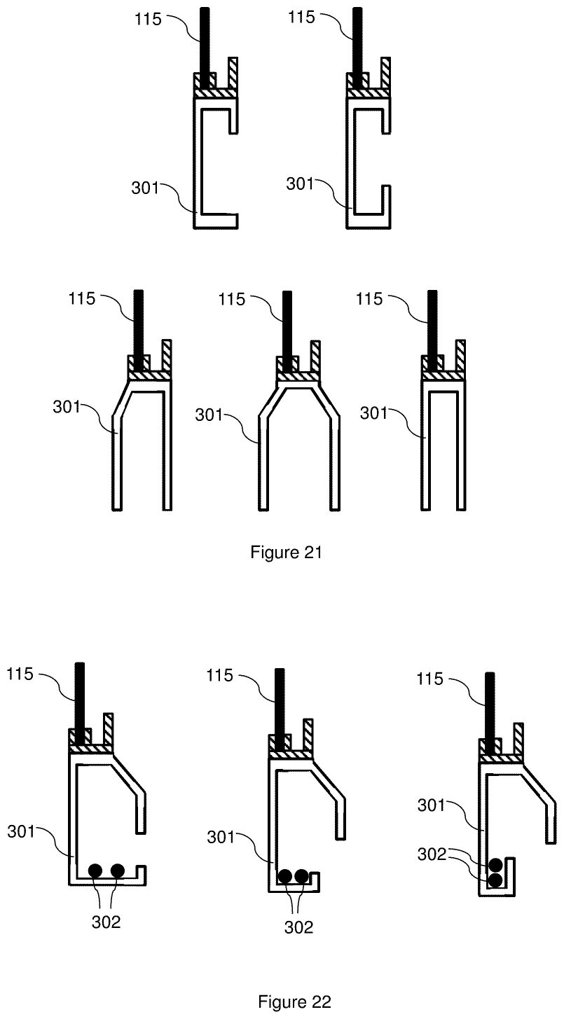

In some embodiments, such as those shown in FIGS. 21 to 23, the system, 100 or 200, also comprises at least one secondary cross-member 301. In particular, such a secondary cross-member 301 is comprised in the structure, 110 or 210.

In these embodiments, the secondary cross-member 301 is arranged under the photovoltaic module 115. In this configuration, the photovoltaic system, 100 or 200, is located on one installation surface 102 and the module 115 is positioned opposite the surface 102. The secondary cross-member 301 has two extremities (not shown), each extremity comprising a fastening. Each fastening is configured to secure an individual extremity of the secondary cross-member 301 to a bar 101 of a system, 100 or 200. Note that the secondary cross-member 301 is arranged and secured between at least two bars 101.

In these embodiments, when the photovoltaic module 115 is rectangular and has two short sides and two long sides, the short side of the photovoltaic module 115 therefore rests along the secondary cross-member 301. In this way, the risks of the photovoltaic module 115 slipping, in a downward vertical movement, are limited, especially during the installation of the photovoltaic system, 100 or 200.

Several embodiments are possible for the shape of the cross-sectional profile of the secondary cross-member 301. These different embodiments are shown in FIGS. 21 to 23.

In some embodiments, the secondary cross-member 301 has a cross-sectional profile with the following shape:
C, as shown by the two shapes at the top of FIG. 21; or
inverted U, as shown by the three shapes in the bottom of FIG. 21.

In some embodiments, such as those shown in FIG. 22, the secondary cross-member 301 also comprises an upper rim in contact with the photovoltaic module 115 and a lower rim configured to hold electric cables 302 connected to the photovoltaic module 115. Preferably, the lower rim is a track. It is noted that the lower rim is defined by a width and a height. In this way, the electric cables 302 are protected and oriented according to predefined constraints on use of the photovoltaic system, 100 or 200.

In some embodiments, such as those shown in FIG. 22, the width of the lower edge of the secondary cross-member 301 shown on the left of FIG. 22 is greater that the widths of the lower edges of the secondary cross-members 301 shown respectively in the centre and on the right of FIG. 22. It can also be seen that the height of the lower edge of the secondary cross-member 301 shown on the right of FIG. 22 is greater that the heights of the lower edges of the secondary cross-members 301 shown respectively in the centre and on the left of FIG. 22.

Preferably, when the modules 115 are serially connected, the positive cable 302 of the photovoltaic modules 115 has a different length, shorter or longer, than the length of the negative cable 302 of the photovoltaic modules 115. Thus, the connectors (not shown) between the modules 115 are protected by the secondary cross-member 301. The modules 115 are serially connected in a chain, referred to as a “string”, known to the person skilled in the art. In other words, the positive cable 302 of a first module 115 is connected to a negative cable 302 of a second module 115 by means of a connector. In this configuration, if the positive cable of the first module 115 has a length equal to the length of the negative cable 302 of the second module 115 then the connector of these two cables 302 arrives at the location of the bar 101. Such an arrangement of the connector is to be avoided in certain cases, in particular when the cables 302 are positioned in the bottom of the modules 115, i.e. at the location of the short side arranged facing the ground 102. In this case, the connector is not protected by the secondary cross-member 301. Therefore, a difference in the length of the positive cable 302 and the negative cable 302 makes it possible to avoid such an arrangement of the connector and thus enables the connector to be protected by the secondary cross-member 301.

In some embodiments (not shown), the secondary cross-member 301 comprises at least one hole, or a perforated shape, on the upper rim or on a back rim. It is noted that the back rim of the secondary cross-member 301 is on the same side as the junction box of the photovoltaic module 115. The hole of the secondary cross-member 301 is configured to facilitate the passage of the electric cables 302 of the photovoltaic module 115.

In some embodiments (not shown), a secondary cross-member 301 is configured to at least partially enclose at least one bar 101.

Thus, the module 115 and structure, 110 or 210, assembly is much more compact, and the stability of the system is therefore increased.

For example, the secondary cross-member 301 has longitudinal and/or transversal slots. Note that such slots are configured to partially or completely enclose a bar 101. In some embodiments (not shown), a fastening of the secondary cross-member 301 comprises at least one intermediate fastening configured to complete the enclosure around at least one bar 101 of the structure, 110 or 210. This therefore strengthens the securing of the cross-member to the bars 101.

In some variants (not shown), a fastening of the secondary cross-member 301 comprises at least one L-shaped intermediate fastening comprising:
an upper part configured to be secured to a bar 101 of the structure, 110 or 210, and
a lower part, perpendicular to the upper part and to the bar 101, and configured to support the secondary cross-member 301.

This strengthens the support of the module 101 by the structure, 110 or 210, making it possible to limit the mechanical stresses due to gravity.

In particular, when a structure, 110 or 210, comprises two bars 101 and two brackets are rigidly attached respectively to each bar 101, the brackets are supports of the extremities of a cross-member 301. Note that the rigid attachment of a bracket to a bar 101 is achieved by any means known to the person skilled in the art. For example, the rigid attachment is achieved by a bolt configured to attach the bar 101 with the upper part of the bracket.

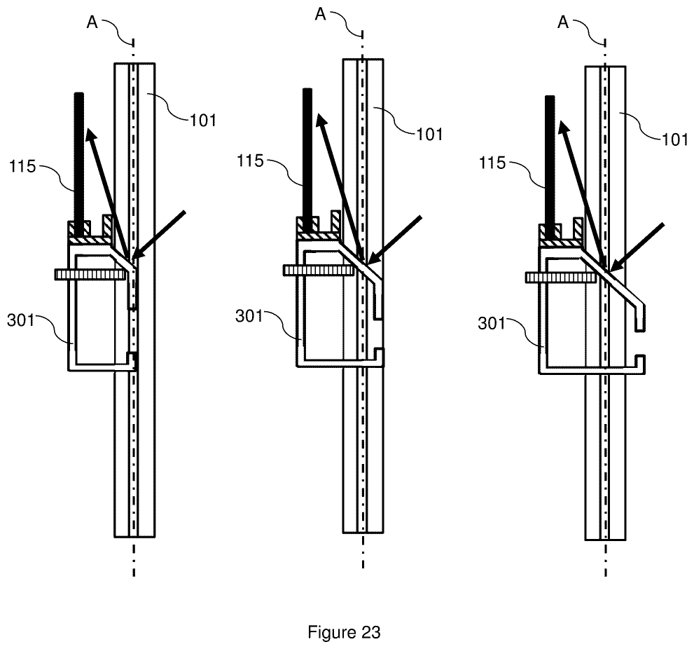

In some embodiments, such as those shown in FIG. 23, the secondary cross-member 301 is at least partially made of a light-reflecting material and has a C-shaped cross-sectional profile. In FIG. 23, the light rays are shown by straight arrows. For example, FIG. 23 shows indirect light radiation on the photovoltaic module 105. The indirect light radiation is the result of the reflection of one or more light rays applied directly on a back surface of the reflective secondary cross-member 301.

In some embodiments, such as those shown in FIGS. 1 and 13 to 15, the system, 100 or 200, comprises no horizontal element connecting two bars 101, for example a girder, cross-member, brace or strut, arranged above a portion of the module 115 not facing an installation ground 102. In other words, no horizontal element connecting two bars 101 or two parallel bars 101 is arranged above a portion of the module 115 farthest from the ground 102. For example when the module is rectangular, the photovoltaic system, 100 or 200, does not comprise any horizontal element connecting two bars arranged above the short side of the module 115 that does not face an installation ground 102. In other words, no horizontal element connecting two parallel bars 101 is arranged above the short side of the module 115 farthest from the ground.

Thus, the quantity of installation materials is reduced. This lowers the cost of the installation, reducing its environmental impact. In addition, the photovoltaic system, 100 or 200, enables improved management of the light irradiating the photovoltaic modules 115, reducing the shadows caused by the use of a more complex structure comprising, in particular, the upper horizontal element. In effect, such a system, 100 or 200, enables maximum solar irradiation in front of and behind the modules. The amount of electricity produced is therefore increased.

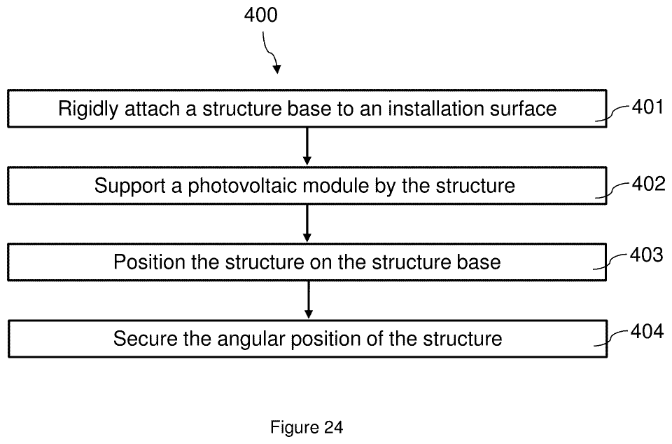

FIG. 24 shows a schematic view of an optional embodiment of the method 400 that is the subject of the present invention. The method 400 is a method for assembling a fixed vertical photovoltaic system. The assembly method 400 comprises at least:
a step 401 of rigidly attaching a structure base to an installation surface;
a step 402 of supporting at least one photovoltaic module on a structure;
a step 403 of positioning the structure on the structure base according to a variable angular position; and
a step 404 of securing the angular position of the structure on the structure base.

During the attachment step 401, the structure base is rigidly attached to the installation surface, for example, using a stake.

During the support step 402, the photovoltaic module is attached to the structure such that the photovoltaic module is supported by the structure.

It is noted that these steps can be performed in succession or in a different order.

Therefore, it is possible to choose to perform, for example, the step of positioning the structure on the structure base before the step of securing a photovoltaic module on a structure.

During the positioning step 403, the structure is positioned on the structure base according to a variable angular position. For example, the different angles defining the angular positions are comprised in a plane generally perpendicular to the installation surface. The choice of the angular position is chosen according to, for example, the steepness of the slopes of the installation site. In some variants, the choice of at least one angular position, defined, for example, by different vertical planes of the system, the planes being orthogonal in relation to the installation surface, is made based on, for example, obstacles present on the installation site.

During the securing step 404, the angular position of the structure on the structure base is secured. In some variants, the structure has a partially secured angular position. In other words, the structure has angular mobility, this mobility only being effective under certain conditions. In particular, such partial mobility is present when specific stresses are applied to the system. For example, when the installation site is subject to earthquakes or ground shaking, the angular position of the structure varies according to the mechanical stresses applied to the system. In other words, without such mechanical stresses, the angular position of the structure is fixed.

In some embodiments, the implementation method 400 comprises:
a step of rigidly attaching a structure base to an installation surface;
a step of positioning a template on the first structure base;
a step of attaching a second structure base to the installation surface, according to the positioning of the template;
a step of rigidly attaching the second structure base to the installation surface;
a step of removing the template;
a step of positioning a structure on the structure bases according to a variable angular position;
a step of supporting a photovoltaic module on a structure; and
a securing step for securing the angular position of the structure on the structure base.

In some variants, the template positioning step is not carried out in the implementation method 400. Alternatively, the position of the second structure base is determined by a precision location system. Such a location system is, for example, a “GPS” system, also called a navigation assistant.

Preferably, the means of the systems, 100 and 200, are configured to implement the steps of the method 400 and their embodiments as described above, and the method 400 and its different embodiments can be implemented by the means of the systems, 100 and 200.

1. Fixed vertical photovoltaic system (100, 200), characterised in that it comprises at least:
a structure (110, 210);
a photovoltaic module (115) supported by the structure;
a structure base (120, 220) configured to be rigidly attached to an installation surface (102);
a means (125) for positioning the structure on the base, the positioning means being at least free to rotate and configured to position the structure according to a variable angular position of installation; and
a means (130) for securing the angular position of the means for positioning the structure relative to the structure base.

2. System (100) according to claim 1, wherein:
the structure (110) comprises at least one bar (101) configured to be rigidly attached to at least one module (115); and
the structure base (120) comprises the means (125) for positioning the structure.

3. System (100) according to claim 2, wherein the positioning means (125) comprises a housing (106) forming a shoulder (107), the bar (101) comprising a shape (108) complementary with the housing.

4. System (100) according to claim 2, wherein the positioning means (125) also comprises at least one slot (109, 121) configured to allow the positioning of the bar (101) according to a plurality of angular positions.

5. System (100) according to claim 1, wherein:
the structure comprises at least one bar (101) configured to be rigidly attached to at least one module (115); and
a positioning means (125) arranged between the structure base (120) and the structure (110).

6. System (100) according to claim 2, wherein one of the elements from amongst the positioning means (125) and the bar (101) comprises a hole (117, 122), the other element comprising a shaft (123), the hole and the shaft forming a pivot link with axis of rotation (B) perpendicular to an axis (A) of the bar.

7. System (100) according to claim 1, which also comprises-an additional means (126) for positioning the structure (110) on the base (120); and the additional positioning means being free to rotate and comprising two elements (114, 116), each element delimiting a different surface, the surfaces parallel and in contact being configured to form a pivot link with axis of rotation (C) intersecting the installation surface (102).

8. System (200) according to claim 1, wherein:
the structure (210) comprises at least one cross-member (201); and
the structure base (220) comprises the means (225) for positioning this cross-member.

9. System (200) according to claim 8, wherein one of the elements from amongst the positioning means (225) and the cross-member (201) comprises a hole (203), the other element comprising a shaft, the hole and the shaft forming a pivot link with axis of rotation perpendicular to an axis (D) of the structure base (220).

10. System (100, 200) according to claim 1, wherein the photovoltaic module (115) is rectangular, the module being secured to the structure (120, 220) and oriented so that a short side of the module is arranged facing the installation surface (102).

11. Method (400) for assembling a fixed vertical photovoltaic system, characterised in that it comprises at least:
a step (401) of rigidly attaching a structure base to an installation surface;
a step (402) of supporting at least one photovoltaic module on a structure;
a step (403) of positioning the structure on the structure base according to at least one variable angular position; and
a step (404) of securing the angular position of the structure on the structure base.
